(19) United States
(12) Patent Application Publication
(10) Pub. No.: US 2025/0234075 A1
(43) Pub. Date: Jul. 17, 2025

(54) METHOD, APPARATUS, DEVICE AND STORAGE MEDIUM FOR MULTIMEDIA CONTENT GENERATION

(71) Applicant: Beijing Zitiao Network Technology Co., Ltd., Haidian District (CN)

(72) Inventors: Jiamin Zhang, Beijing (CN); Yongjie Wang, Beijing (CN); Qihua Wang, Beijing (CN); Yifei Bi, Beijing (CN); Rong Bai, Beijing (CN); Hao Huang, Beijing (CN)

(21) Appl. No.: 18/926,910

(22) Filed: Oct. 25, 2024

(30) Foreign Application Priority Data
Jan. 15, 2024 (CN) 202410059722.8

(51) Int. Cl. H04N 21/854; H04N 21/43

(52) U.S. Cl. CPC H04N 21/854; H04N 21/4302

(57) ABSTRACT

According to embodiments of the disclosure, a method, an apparatus, a device and a storage medium for multimedia content generation are provided. The method includes receiving concurrently captured image data and input sound data from a target object; generating audio data based at least on converted sound data corresponding to the input sound data, the converted sound data being obtained by performing a target conversion operation on at least a portion of the input sound data; temporally aligning the audio data with the image data according to a time delay associated with the converted sound data; and generating multimedia content associated with the target object based on the aligned audio data and image data. In this way, the problem of audio-picture asynchronization of streaming sound conversion in a real-time content generation scene can be solved, such that streaming sound conversion can be used in the real-time content generation scene.

### CROSS-REFERENCE

The present application claims priority to Chinese Patent Application No. 202410059722.8, filed on Jan. 15, 2024, and entitled “METHOD, APPARATUS, DEVICE AND STORAGE MEDIUM FOR MULTIMEDIA CONTENT GENERATION”, the entirety of which is incorporated by reference.

### FIELD

Example embodiments of the present disclosure generally relate to the field of computers, and more particularly, to a method, an apparatus, a device, and a computer-readable storage medium for multimedia content generation.

### BACKGROUND

More and more applications are currently designed to provide a variety of services to users. For example, users may browse, comment, forward various types of content in an application, including, for example, video, images, image collections, audio, and the like. In addition, an application of the content sharing type also supports shooting multimedia content, such as a video, an image collection with sound, and the like.

### SUMMARY

In a first aspect of the present disclosure, a method for multimedia content generation is provided. The method includes: receiving concurrently captured image data and input sound data from a target object; generating audio data based at least on converted sound data corresponding to the input sound data, the converted sound data being obtained by performing a target conversion operation on at least a portion of the input sound data; aligning the audio data with the image data in time based on a time delay associated with the converted sound data; and generating multimedia content associated with the target object based on the aligned audio data and image data.

In a second aspect of the present disclosure, an apparatus for multimedia content generation is provided. The apparatus includes: a data receiving module configured to receive concurrently captured image data and input sound data from a target object; an audio processing module configured to generate audio data based at least on converted sound data corresponding to the input sound data, the converted sound data being obtained by performing a target conversion operation on at least a portion of the input sound data; a first aligning module configured to align the audio data with the image data in time based on a time delay associated with the converted sound data; and a first merging module configured to generate multimedia content associated with the target object based on the aligned audio data and the image data.

In a third aspect of the present disclosure, there is provided an electronic device, the device including at least one processing unit; and at least one memory coupled to the at least one processing unit and storing instructions for execution by the at least one processing unit that, when executed by the at least one processing unit, cause the electronic device to perform the method of the first aspect.

In a fourth aspect of the present disclosure, a computer readable storage medium is provided, where the computer readable storage medium stores a computer program thereon, and the computer program is executable by a processor to implement the method in the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure can be implemented;

FIG. 2 illustrates a schematic diagram of an example processing architecture for audio data according to some embodiments of the present disclosure;

FIG. 3A illustrates a schematic diagram of an example user interface for initiating content capture according to some embodiments of the present disclosure;

FIG. 3B illustrates a schematic diagram of an example user interface for content capture according to some embodiments of the present disclosure;

FIG. 4 illustrates a schematic diagram of an example data flow for delay compensation according to some embodiments of the present disclosure;

FIG. 5 illustrates an example signaling diagram for audio processing according to some embodiments of the present disclosure;

FIG. 6 illustrates a flowchart of a process for multimedia content generation according to some embodiments of the present disclosure;

FIG. 7 illustrates a block diagram of an apparatus for multimedia content generation according to some embodiments of the present disclosure; and

FIG. 8 illustrates a block diagram of a device capable of implementing various embodiments of the present disclosure.

### DETAILED DESCRIPTION

It should be understood that, before the technical solutions disclosed in the embodiments of the present disclosure are used, the user should be informed of the type of the personal information, the usage range, the usage scenario, and the like related to the present disclosure in an appropriate manner and the authorization of the user should be obtained according to relevant legal regulations.

For example, in response to receiving an active request from a user, prompt information is sent to the user to explicitly prompt the user that an operation requested by the user will require acquisition and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, in response to receiving an active request of a user, a manner of sending prompt information to the user may be, for example, a manner of a pop-up window, where the pop-up window may present the prompt information in a text manner. In addition, the popup window may also carry a selection control for the user to select ‘agree’ or ‘don't agree’ to provide personal information to the electronic device.

It can be understood that, the above notification and acquisition of the user authorization process are merely exemplary, and do not limit the implementation of the present disclosure, and other methods meeting relevant legal regulations may also be applied to the implementation of the present disclosure.

It is to be understood that the data involved in the technical solution (including but not limited to the data itself, the acquisition or use of the data) should comply with the requirements of the corresponding legal regulations and related provisions.

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

Herein, unless explicitly stated otherwise, “performing a step in response to A” does not mean that the step is performed immediately after “A”, but may include one or more intermediate steps.

In the description of the embodiments of the present disclosure, the term “including” and the like should be understood as open-ended including, that is, “including but not limited to”. The term “based on” should be read as “based at least in part on.” The term “one embodiment” or “the embodiment” should be read as “at least one embodiment”. The term “some embodiments” should be understood as “at least some embodiments.” Other explicit and implicit definitions may also be included below. The terms “first”, “second”, etc. may refer to different or identical objects. Other explicit and implicit definitions may also be included below.

As used herein, the term “model” may learn associations between corresponding inputs and outputs from training data, such that after training, corresponding output may be generated for given input. The generation of the model may be based on a machine learning technique. Deep learning is a machine learning algorithm that processes inputs and provides corresponding outputs by using a multi-tiered processing unit. A “model” may also be referred to herein as a “machine learning model,” a “machine learning network,” or a “network”, and these terms may be used interchangeably herein. A model may in turn include various types of processing units or networks.

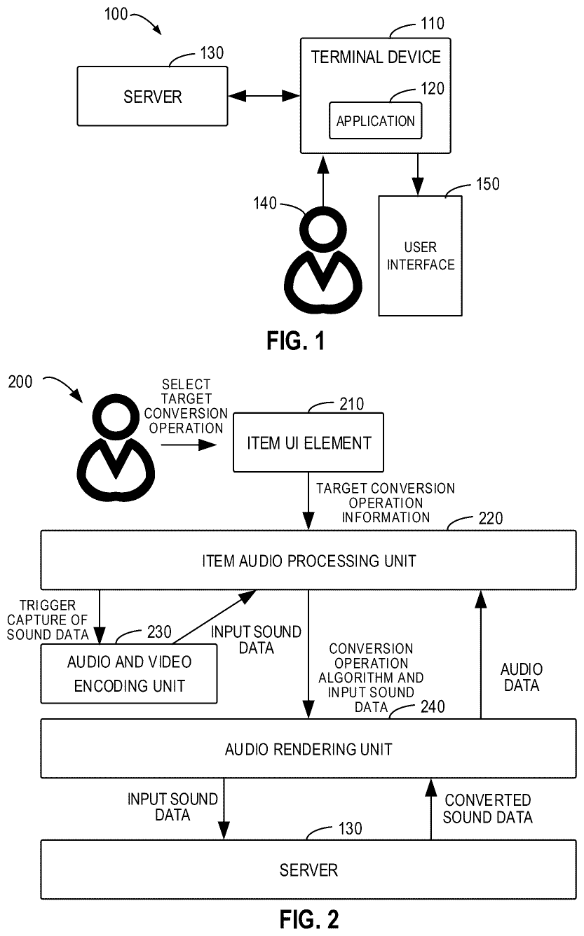

FIG. 1 illustrates a schematic diagram of an example environment 100 in which embodiments of the present disclosure can be implemented. In this example environment 100, an application 120 is installed in a terminal device 110. The user 140 may interact with the application 120 via the terminal device 110 and/or an attachment device of the terminal device 110. Exemplarily, the application 120 can be a content generation application, a content sharing application, or a social application, it may can provide services related media content to the user 140, including viewing, commenting, forwarding, authoring (e.g., shooting and/or editing), publishing, etc. of content. “Media content” may include one or more types of content, such as video, image, motion picture, image collection, audio, text, etc. The applications 120 may support user 140 in authoring multimedia content. Such multimedia content may include image data and audio data.

In the environment 100 of FIG. 1, the terminal device 110 may present a user interface 150 of the application 120. The user interface 150 may include various types of interfaces that the application 120 can provide, such as a content presentation interface, a content authoring interface, a content publishing interface, a messaging interface, a personal homepage, and the like. The application 120 may provide content browsing functionality to browse the various types of content published in the application 120. The application 120 may also provide content authoring functionality including shooting, uploading, editing, and/or publishing media content.

In some embodiments, the terminal device 110 communicates with the server 130 to enable the provision of services to the applications 120. The terminal device 110 may be any type of mobile terminal, fixed terminal, or portable terminal including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination of the foregoing, including accessories and peripherals for these devices, or any combination thereof. In some embodiments, the terminal device 110 can also support any type of interface to a user (such as “wearable” circuitry, etc.). The server 130 may be various types of computing systems/servers capable of providing computing capabilities including, but not limited to, mainframe computers, edge computing nodes, computing devices in a cloud environment, etc.

It should be appreciated that the structure and functionality of the various components in the environment 100 are described for exemplary purposes only and are not intended to imply any limitation on the scope of the disclosure.

As mentioned above, a user may create multimedia content through an application. When creating the multimedia content, additional processing to the captured audio data may be required, such as a conversion operation. For example, Timbre Conversion (VC) refers to converting an input user voice into a sound of a specified timbre. The specified timbre may be an existing timbre in a timbre library or a timbre that has been authorized for use. Fun voice changing can be realized by using timbre conversion, thereby enriching voice interaction experience.

However, such additional processing may consume relatively large resources, resulting in a time delay. In some cases, such additional processing can be relatively complex (e.g., for the VC case), thus requiring server-dependency. In turn, communication with the server may cause further delays, such as network delays and server-side processing delays. These delays may cause a problem that the sound and picture are asynchronous when the scene is shot in real time, so that the real-time shot scene cannot be satisfied.

To this end, embodiments of the present disclosure provide an improved solution for generating multimedia content. In this solution, image data and input sound data from a target object captured concurrently are received. By performing a target conversion operation on at least a portion of the input sound data, converted sound data corresponding to the input sound data is obtained. Audio data is generated based at least on the converted sound data. The audio data is aligned with the image data in time based on a time delay associated with the converted sound data, to generate multimedia content associated with the target object.

In the embodiments of the present disclosure, audio data and image data in the multimedia content are aligned according to a time delay associated with the converted sound data, thereby achieving audio and picture synchronization. In other words, the audio track is aligned with the video track in time according to the delay of the audio link, which is an audio link-based delay compensation scheme. In this manner, the problem of audio and video asynchronization of streaming voice conversions (e.g., VC) in real-time content generation scenes can be solved, enabling streaming voice conversion to be used in real-time content generation scenes.

Some example embodiments of the present disclosure will be described below with continued reference to the accompanying drawings.

FIG. 2 illustrates a schematic diagram of an example processing architecture 200 for audio data according to some embodiments of the disclosure. The example processing architecture 200 of FIG. 2 will be described with reference to FIG. 1. As shown in FIG. 2, the user 140 interacts with the application 120 via an item user interface (UI) element 210 presented on the terminal device 110. The item UI element 210 receives a user selection of a sound conversion operation to be performed. The sound conversion operation to be performed may also be referred to as a target conversion operation. Alternatively, in some embodiments, the target conversion operation may be set by default or randomly without user selection.

The target conversion operation may include any suitable conversion that is suitable to perform on the sound data. For example, the target conversion operation may include a timbre conversion, i. e., converting the input voice to a user-specified, randomly selected, or default timbre. As another example, the target conversion operation may include pitch conversion, i. e., the input sound is raised or lowered in pitch. It should be appreciated that the sound conversion operations listed herein are exemplary only and are not intended to limit the scope of the present disclosure.

In response to a user operation for the target conversion operation, the item UI element 210 may transmit target conversion operation information to the item audio processing unit 220. Thus, the item audio processing unit 220 may learn the sound conversion operation to be performed. If the user 140 triggered content shooting, the item audio processing unit 220 may transmit a message or notification to the audio and video encoding unit 230 to trigger capture of the sound data. For example, the audio and video encoding unit 230 may trigger capture of sound data via a microphone of the terminal device 110 or other suitable device. The captured sound data may come from a target object, which may be any suitable object in an environment in which the microphone is located, such as the user 140 or other person, animal, physical sound source, etc.

In addition to capture of input sound data, if the user 140 triggered content shooting, the capture of image data is also triggered. For example, the image data may be captured via a camera of the terminal device 110. In some embodiments, the image data may include a facial image of the target object, such as a facial image of the user 140. Note that image data and input sound data are captured concurrently, e.g., captured at the same time.

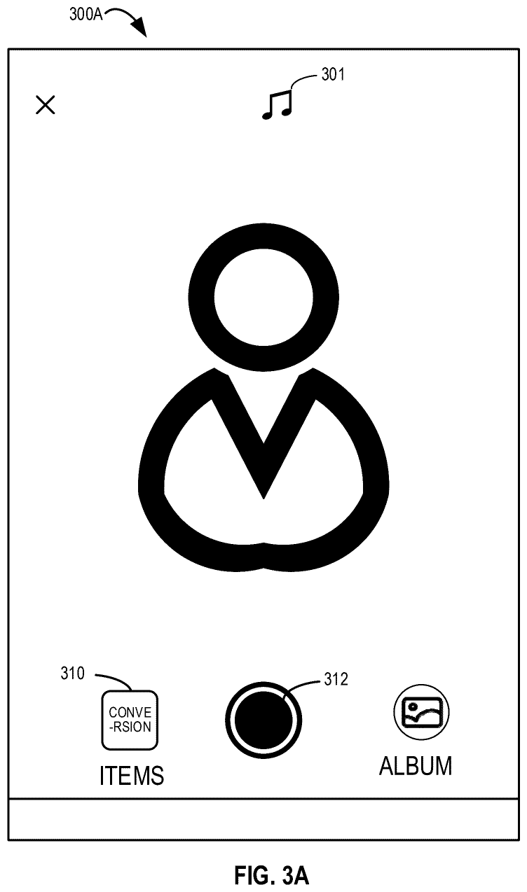

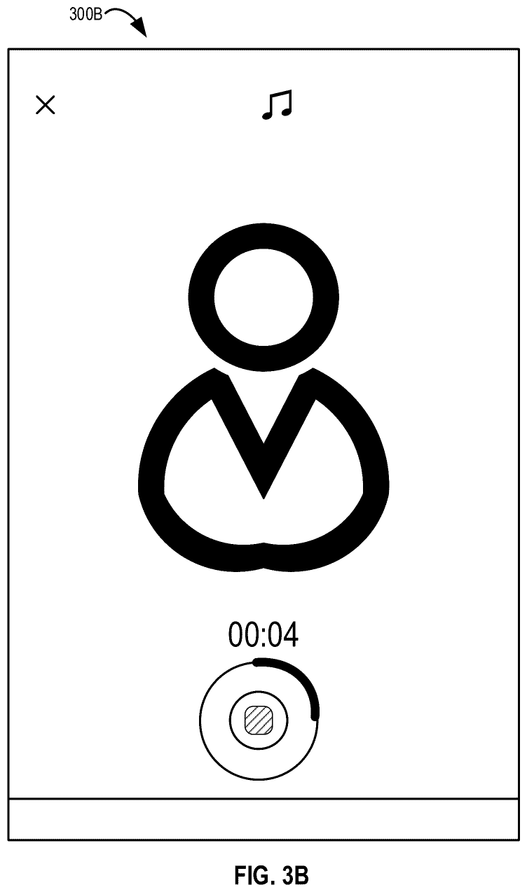

An example scenario is described with reference to FIGS. 3A and 3B. FIG. 3A illustrates a schematic diagram of an example user interface 300A for initiating content shooting according to some embodiments of the present disclosure. As shown in FIG. 3A, a selection entry 310 for a sound conversion operation is displayed in the user interface 300A. Via the selection entry 310, the user 140 can select a conversion operation desired to be performed on input sound data, e.g., selecting or specifying a specific timbre in the case of VC. If a shooting control 312 is triggered, the terminal device 110 may start concurrently capturing image data and inputting sound data. Accordingly, the terminal device 110 may present an example user interface 300B of the content capture shown in FIG. 3B. In this example, a real-time captured image of the user 140 is displayed in the user interface 300B.

It should be understood that the example scenes and user interfaces described with respect to FIGS. 3A and 3B are for illustration purposes only and are not intended to be limiting. The delay compensation scheme according to an embodiment of the present disclosure may be applicable to any image data and sound data captured concurrently.

With continued reference to FIG. 2, the captured input sound data may be returned to the item audio processing unit 220 via the audio and video encoding unit 230. The item audio processing unit 220 may in turn transmit the input sound data to the audio rendering unit 240, and may request the audio rendering unit 240 to create a conversion operation algorithm for the target conversion operation, or transmit the conversion operation algorithm created by itself to the audio rendering unit 240. That is, the target conversion is performed while capturing the sound data. A streaming conversion, for example, a streaming timbre conversion is performed on the input sound data.

Depending on the particular implementation or capabilities of the terminal device 110, the target conversion operation may be performed by any suitable entity. For example, the audio rendering unit 240 may perform a target conversion operation, e.g., a timbre conversion, on at least a portion of the input sound data to derive converted sound data. Alternatively, the audio rendering unit 240 may transmit the input sound data to the server 130 for the server 130 to perform the target conversion operation. Accordingly, the audio rendering unit 240 may receive the converted sound data from the server 130. For example, an interface for streaming sound conversion (e.g., streaming timbre conversion) may be configured. The interface may include various parameters for sound conversion for exchanging data and information required for the sound conversion between the server 130 and the terminal device 110.

Note that the target conversion operation may be performed on all of the input sound data, or may be performed on a part of the input sound data. For example, if the input sound data contains a voice of a person and background noise, the target conversion operation may be performed only on the voice section. Embodiments of the present disclosure are not limited in respect of how the target conversion operation is performed.

After obtaining the converted sound data, the audio rendering unit 240 may generate audio data based at least on the converted sound data. In some embodiments, the terminal device 110 may play background sound data, e.g., background music, etc., concurrently with the capture of input sound data and image data. Exemplarily, if the user 140 selects or specifies background music through the background music entry 301 in the user interface 300A, the terminal device 110 may simultaneously play the selected background music after the shooting control 312 is triggered.

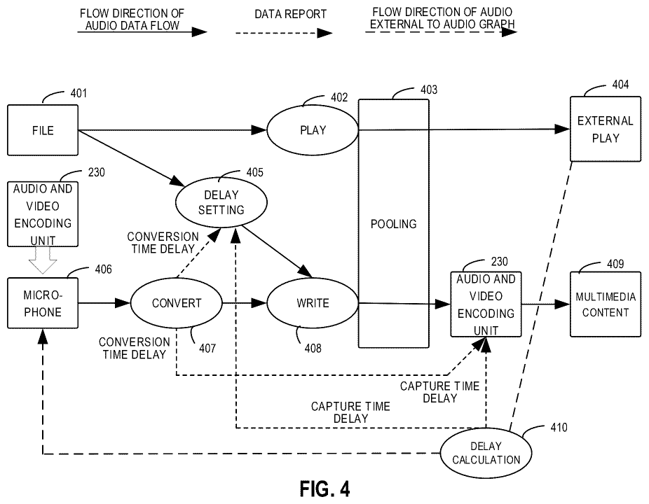

The playback of the background sound may cause a problem that the sound of the target object is not synchronized with the background sound, i.e. a sound-sound desynchronization problem. To this end, in such embodiments, the audio rendering unit 240 may align the converted sound data with the background sound data in time, and may generate audio data based on the aligned converted sound data and background sound data. An example embodiment of temporal alignment will be described below with reference to FIG. 4.

In the case that the conversion is successful, the audio rendering unit 240 transmits the obtained audio data to the item audio processing unit 220. If the conversion fails, the audio rendering unit 240 may transmits a status code to the item audio processing unit 220 indicating the failure.

The item audio processing unit 220 may forward the audio data to the audio and video encoding unit 230, or the audio rendering unit 240 may directly transmit the audio data to the audio and video encoding unit 230. The audio and video encoding unit 230 may align the audio data with the concurrently captured image data in time based on a time delay associated with the converted sound data. The audio and video encoding unit 230 may then generate multimedia content associated with the target object based on the aligned audio data and image data. For example, the audio and video encoding unit 230 may align an audio track with a video track according to a time delay, thereby generating a corresponding multimedia file.

The time delay described above may include any delay in time related to capture, processing, etc. of the converted sound data. Such a time delay may be understood, for example, as an actual difference between a timing the sound is emitted and a timing the corresponding audio data is used to generate the multimedia content. In some embodiments, the time delay may include a conversion time delay caused by obtaining the converted sound data based on the input sound data. The conversion time delay includes at least the time consumed to perform the target conversion operation. If the target conversion operation is performed at least in part by the server 130 or other remote device, the conversion time delay may also include a delay caused by communication between the terminal device 110 and the server 130 or other remote device. In such embodiments, the terminal device 110 may transmit, to a remote device (e.g., server 130), input sound data and a request for performing the target conversion operation on the input sound data, and may receive the converted sound data from the remote device. The terminal device 110 may obtain the conversion time delay based on the transmission of the input sound data and the reception of the converted sound data. For example, the terminal device 110 may calculate the elapsed time from the transmission of input sound data to the reception of converted sound data. In another example, the interface may include a parameter for obtaining the conversion time delay, and the terminal device 110 may obtain the conversion time delay through the interface.

Alternatively, or additionally, the time delay may include a capture time delay caused by obtaining the input sound data with a microphone. For example, sound reaches a microphone from a sound source and is converted into sound data by the microphone, and the sound data in turn reaches an audio rendering unit 240 via the audio and video encoding unit 230 and an item audio processing unit 220. This sound data link may cause the capture time delay.

The audio data and the image data may be aligned in time by performing time delay compensation when performing audio and video encoding. In this way, the sound and picture alignment of the generated multimedia content can be achieved. For example, the user's 140 voice and mouth shape are consistent.

Example processing architectures for delay compensation are described above. It should be understood that the functional descriptions and division of various units shown in FIG. 2 are exemplary only and are not intended to limit the scope of the present disclosure. The specific functions of the units may be divided in any suitable manner. Furthermore, the item UI element 210, the item audio processing unit 220, the audio and video encoding unit 230 and the audio rendering unit 240, etc. may be implemented at least partially at the terminal device 110, or at least partially at the server 130.

A schematic diagram of an example data flow 400 for delay compensation is described below with respect to FIG. 4. In the data flow 400, except the audio and video encoding unit 230, the remaining nodes may be at least a portion of an audio graph, which, for example, may be performed by the audio rendering unit 240. Also, in this example, a case where background sound data (e.g., background music) is played simultaneously is shown.

As shown in FIG. 4, at a file node 401, a file storing background sound data is read, and after that, processing of the background sound data is divided into two branches, a branch for concurrent playback and a branch for writing multimedia content. In the branch for concurrent playback, the read background sound data is delivered to the playing node 402, and reaches external playing node 404 via the pooling node 403. At the external playing node 404, background sound data, such as background music, may be played through a sound output device (e.g., a speaker) of the terminal device 110 or other sound output device attached. The played background sound data may in turn be captured by the microphone and returned to the microphone node 406 in the audio graph. Meanwhile, as described with reference to FIG. 2, the audio and video encoding unit 230 may trigger the microphone to capture the input sound data of the target object, and the input sound data may also enter the processing flow of the audio graph through the microphone node 406.

At the delay calculation node 410, a capture time delay caused by capturing audio data (e.g., which may include input audio data and background sound data) with a microphone may be calculated. The capture delay time may be reported to the audio and video encoding unit 230 and the delay setting node 405.

The data flow in the audio graph is continuously described. The played background sound may enter the processing flow of the audio graph through the microphone node 406 along with the captured sound of the target object. At conversion node 407, at least a portion of the input sound data is subject to a target conversion operation, resulting in the converted sound data. For example, the audio rendering unit 240 may perform the target conversion operation, or may obtain the converted sound data from the server 130, as described above with reference to FIG. 2. A conversion time delay may also be obtained at the conversion node 407. For example, a parameter for obtaining a conversion time delay may be provided in the interface for the streaming timbre conversion to obtain the conversion time delay via the interface.

The conversion time delay may be reported to the audio and video encoding unit 230 and a delay setting node 405. The delay setting node located in a branch of the background sound data for writing multimedia content. The delay setting node 405 may obtain a conversion time delay and a capture time delay. As such, the delay setting node 405 may set a total time delay, e.g., adding the conversion time delay and the capture time delay together, and transmit the set time delay to the writing node 408.

The writing node 408 may receive two paths of sound data, namely the converted sound data from the conversion node 407 and the background sound data from the delay setting node 405. At the writing node 408, the converted sound data is aligned with the background sound data in time based on the set time delay, and audio data is generated based on the aligned converted sound data and background sound data.

The converted sound data may be considered as coming from a recording link, while the background sound data from the file node 401 may be considered as coming from a non-recording link. The two links may be aligned in any suitable alignment way. In some embodiments, the start position of the background sound data may be shifted backwards in time according to the time delay. That is, in the non-recording link, the background sound data is delayed in time by a delay amount in the recording link.

Thus, it is possible to realize a delay scheme in which both recording and unrecording links are implemented in terms of audio. In this way, for finally generated multimedia content, sound-sound synchronization may be implemented.

The data flow 400 is continuously described. The audio data generated at the writing node 408 has implemented asynchronization of the sounds of the different links. Such audio data may arrive at the audio and video encoding unit 230 via the pooling node 403. Although not shown, it should be understood that audio and video encoding unit 230 also receives image data captured concurrently with the input audio data. In addition, the audio and video encoding unit 230 also obtains a total time delay, including a conversion time delay and a capture time delay. The audio and video encoding unit 230, in turn, may align the audio data with the image data in time based on a time delay, and generate the multimedia content 409, e.g., a video, based on the aligned audio data and image data.

The audio track and the video track may be aligned in any suitable alignment manner. In some embodiments, the audio and video encoding unit 230 may determine a target data amount based on a time delay and a target code rate, and may remove a target data amount of audio data from a start position of the audio data to align the audio data with the image data in time. Exemplarily, the audio and video encoding unit 230 may calculate a sum of the conversion time delay and the capture time delay, and calculate the number of samples to be discarded based on the delay and the code rate, for example, a delay value is multiplied by the code rate as the number of samples. Then, the first sample number of samples in the audio data may be discarded. Therefore, delay compensation for sound and picture may be implemented, thereby implementing consistent sound and picture.

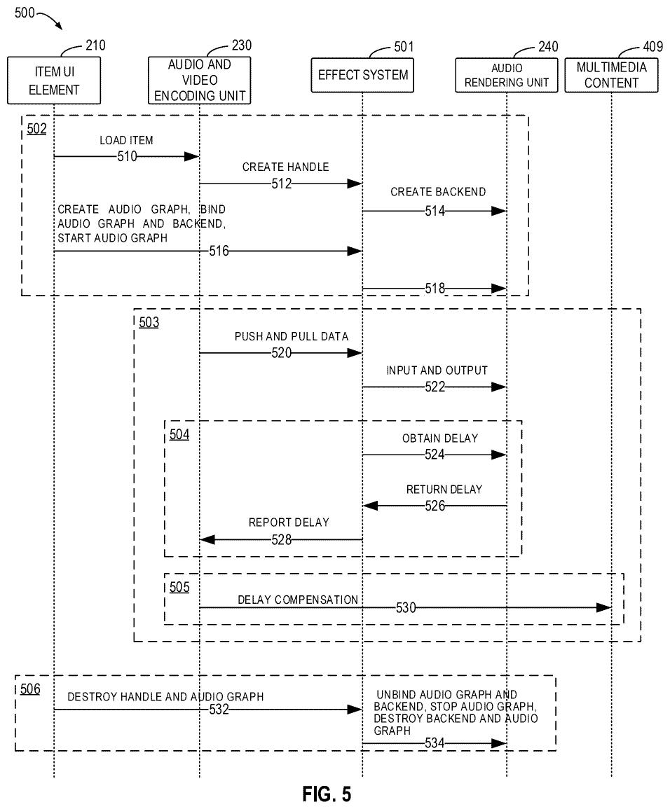

FIG. 5 illustrates an example signaling diagram 500 for audio processing according to some embodiments of the present disclosure. The signaling diagram 500 relates to the item UI element 210, an audio and video encoding unit 230, an effect system 501, an audio rendering unit 240 and a multimedia content 409. The item audio processing unit 230 shown in FIG. 2 may be considered as a part of the effect system 501.

In an initialization phase 502, in response to a target conversion operation being selected or specified, at 510, the item UI element 210 may instruct the audio and video encoding unit 230 to load an item. At 512, the audio and video encoding unit 230 may instruct the effect system 501 to create a corresponding handle. At 514, the effect system 501 may instruct the audio rendering unit 240 to create a corresponding backend.

At 516, the item UI element 210 may instruct the effect system 501 to interact a message, the message indicates to create an audio graph, bind the audio graph and the backend, and start the audio graph. At 518, the effect system 501 may forward the message to the audio rendering unit 240. Accordingly, the audio rendering unit 240 may create an audio map, bind the audio graph and the backend, and start the audio graph.

Next, in the data flow processing phase 503, the audio and video encoding unit 230 may push and pull concurrently captured audio data and image data to the effect system 501 at 520. At 522, the effect system 501 may transmit sound data to the audio rendering unit 240 to perform a target conversion operation.

Next, the delay reporting phase 504 proceeds. At 524, the effect system 501 may transmit a message to the audio rendering unit 240 to request obtaining of a time delay, such as the conversion time delay and the capture time delay described above. At 526, the audio rendering unit 240 may return the time delay to the effect system 501. At 528, the effect system 501 may report the obtained time delay to the audio and video encoding unit 230. Next, a delay compensation phase 505 is entered. At 530, the audio and video encoding unit 230 may generate the multimedia content 409 by delay compensation, as described above.

After streaming generation of the multimedia content 409 ends, an item unloading phase 506 is entered. At 532, the item UI element 210 may interact with the effect system 501 to instruct it to destroy the handles and audio graph. The effect system 501 may destroy the handles and, at 534, it may instruct the audio rendering unit 240 to unbind the audio graph and the backend, stop the audio graph, and destroy the audio graph and the backend. Accordingly, the audio rendering unit 240 may unbind the audio graph and the backend, stop the audio graph, and destroy the backend and audio graph.

The interactions between the various elements described above with reference to FIG. 5 are merely exemplary and are not intended to be limiting. In embodiments of the present disclosure, any suitable number and function of units may be provided to implement delay compensation.

### Example Process, Apparatus and Device

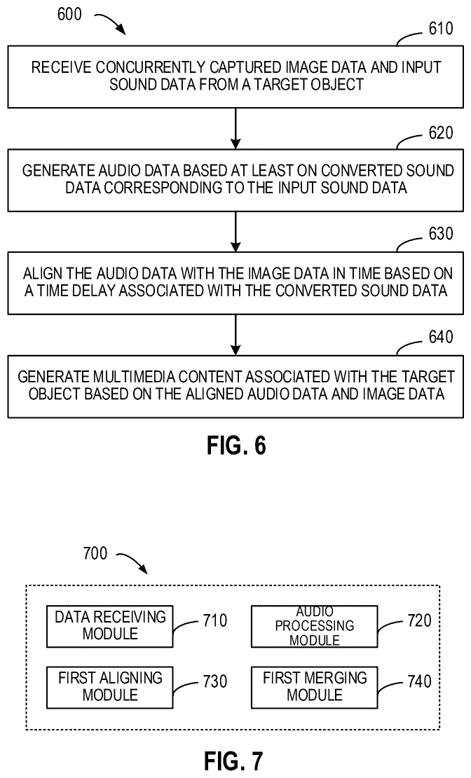

FIG. 6 illustrates a flowchart of a process 600 for multimedia content generation according to some embodiments of the disclosure. The process 600 may be implemented at terminal equipment 110 or at terminal device 110 and server 130.

At block 610, the terminal device 110 receives concurrently captured image data and input sound data from a target object. At block 620, the terminal device 110 generates audio data based at least on converted sound data corresponding to the input sound data, the converted sound data being obtained by performing a target conversion operation on at least a portion of the input sound data. At block 630, the terminal device 110 aligns the audio data with the image data in time based on a time delay associated with the converted audio data. At block 640, the terminal device 110 generates multimedia content associated with the target object based on the aligned audio data and image data.

In some embodiments, generating the audio data includes: obtaining background sound data played concurrently with capturing the input sound data and the image data; aligning the converted sound data with the background sound data in time based on the time delay; and generating the audio data based on the aligned converted sound data and background sound data.

In some embodiments, aligning the converted sound data with the background sound data in time includes shifting a start position of the background sound data backwards in time based on the time delay.

In some embodiments, aligning the audio data with the image data in time includes: determining a target data amount based on the time delay and a target code rate; and aligning the audio data with the image data in time by removing the target data amount of the audio data from a start position of the audio data.

In some embodiments, the time delay includes at least one of a conversion time delay caused by obtaining the converted sound data based on the input sound data, or a capture time delay caused by obtaining sound data with a microphone.

In some embodiments, the process 600 further includes: transmitting, to a remote device, the input sound data and a request for performing the target conversion operation on the input sound data; receiving the converted sound data from the remote device; and obtaining the conversion time delay based on the transmission of the input sound data and the reception of the converted sound data.

In some embodiments, the input sound data includes a voice of the target object, and the target conversion operation includes converting the voice into a user-specified timbre.

In some embodiments, the image data includes a facial image of the target object.

In some embodiments, the process 600 further includes: receiving user input indicating content shooting; and in response to the user input, triggering concurrent capture of the image data and the input sound data.

FIG. 7 illustrates a schematic structural block diagram of an apparatus 700 for multimedia content generation according to some embodiments of the present disclosure. The apparatus 700 may be implemented as or included in a terminal device 110. The various modules/components in the apparatus 700 may be implemented by hardware, software, firmware, or any combination thereof.

As shown, the apparatus 700 includes a data receiving module 710 configured to receive concurrently captured image data and input sound data from a target object. The apparatus 700 also includes an audio processing module 720 configured to generate audio data based at least on converted sound data corresponding to the input sound data, the converted sound data being obtained by performing a target conversion operation on at least a portion of the input sound data. The apparatus 700 also includes a first alignment module 730 configured to align the audio data with the image data in time based on a time delay associated with the converted sound data. The apparatus 700 also includes a first merging module 740 configured to generate multimedia content associated with the target object based on the aligned audio data and the image data.

In some embodiments, the first merging module includes: a sound data obtaining module configured to obtain background sound data played concurrently with capturing the input sound data and the image data; a second aligning module configured to align the converted sound data with the background sound data in time based on the time delay; and a second merging module configured to generate the audio data based on the aligned converted sound data and background sound data.

In some embodiments, the second aligning module is further configured to shift a start position of the background sound data backwards in time based on the time delay.

In some embodiments, the first aligning module 730 is further configured to: determine a target data amount based on the time delay and a target code rate; and align the audio data with the image data in time by removing the target data amount of the audio data from a start position of the audio data.

In some embodiments, the time delay includes at least one of a conversion time delay caused by obtaining the converted sound data based on the input sound data, or a capture time delay caused by obtaining sound data with a microphone.

In some embodiments, the apparatus 700 further includes: a data transmitting module configured to transmit, to a remote device, the input sound data and a request for performing the target conversion operation on the input sound data; a data receiving module configured to receive the converted sound data from the remote device; and a delay obtaining module configured to obtain the conversion time delay based on the transmission of the input sound data and the reception of the converted sound data.

In some embodiments, the input sound data includes a voice of the target object, and the target conversion operation includes converting the voice to have a user-specified timbre.

In some embodiments, the image data includes a facial image of the target object.

In some embodiments, apparatus 700 further includes: a user input receiving module configured to receive a user input indicating content shooting; and a triggering module configured to trigger concurrent capture of the image data and the input sound data in response to the user input.

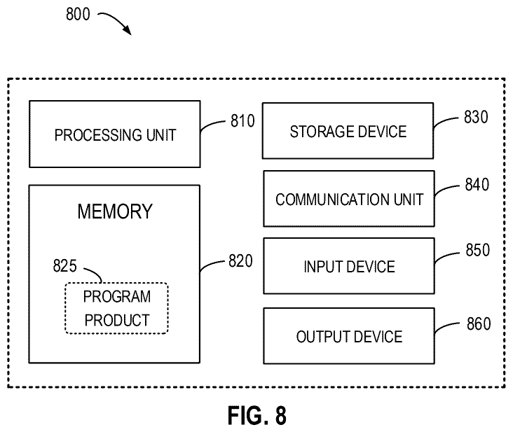

FIG. 8 illustrates a block diagram illustrating an electronic device 800 in which one or more embodiments of the present disclosure may be implemented. It should be appreciated that the electronic device 800 shown in FIG. 8 is merely exemplary and should not constitute any limitation on the functionality and scope of the embodiments described herein. The electronic device 800 shown in FIG. 8 may be used to implement the terminal device 110 of FIG. 1.

As shown in FIG. 8, the electronic device 800 is in the form of a general-purpose electronic device. Components of the electronic device 800 may include, but are not limited to, one or more processors or processing units 810, a memory 820, a storage device 830, one or more communications units 840, one or more input devices 1250, and one or more output devices 860. The processing unit 810 may be an actual or virtual processor and can perform various processes according to programs stored in the memory 820. In a multiprocessor system, a plurality of processing units executes computer executable instructions in parallel, so as to improve the parallel processing capability of the electronic device 800.

The electronic device 800 typically includes a number of computer storage media. Such media may be any available media that are accessible by electronic device 800, including, but not limited to, volatile and non-volatile media, removable and non-removable media. The memory 820 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium such as a flash drive, a magnetic disk, or any other medium that can be used to store information and/or data and that can be accessed within the electronic device 800.

The electronic device 800 may further include additional removable/non-removable, volatile/nonvolatile storage media. Although not shown in FIG. 8, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 820 may include a computer program product 825 having one or more program modules configured to perform various methods or actions of various embodiments of the present disclosure.

The communication unit 840 implements communication with other electronic devices through a communication medium. In addition, functions of components of the electronic device 800 may be implemented by a single computing cluster or a plurality of computing machines, and these computing machines can communicate through a communication connection. Thus, the electronic device 800 may operate in a networked environment using logical connections to one or more other servers, network personal computers (PCs), or another network node.

The input device 850 may be one or more input devices such as a mouse, keyboard, trackball, etc. The output device 860 may be one or more output devices such as a display, speaker, printer, etc. The electronic device 800 may also communicate with one or more external devices (not shown) such as a storage device, a display device, or the like through the communication unit 840 as required, and communicate with one or more devices that enable a user to interact with the electronic device 800, or communicate with any device (e.g., a network card, a modem, or the like) that enables the electronic device 800 to communicate with one or more other electronic devices. Such communication may be performed via an input/output (I/O) interface (not shown).

According to an exemplary implementation of the present disclosure, a computer readable storage medium is provided, on which computer-executable instructions are stored, wherein the computer executable instructions are executed by a processor to implement the method described above. According to an example implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for multimedia content generation, comprising:
receiving concurrently captured image data and input sound data from a target object;
generating audio data based at least on converted sound data corresponding to the input sound data, the converted sound data being obtained by performing a target conversion operation on at least a portion of the input sound data;
aligning the audio data with the image data in time based on a time delay associated with the converted sound data; and
generating multimedia content associated with the target object based on the aligned audio data and image data.

2. The method of claim 1, wherein generating the audio data comprises:
obtaining background sound data played concurrently with capturing the input sound data and the image data;
aligning the converted sound data with the background sound data in time based on the time delay; and
generating the audio data based on the aligned converted sound data and background sound data.

3. The method of claim 2, wherein aligning the converted sound data with the background sound data in time comprises:
shifting a start position of the background sound data backwards in time based on the time delay.

4. The method of claim 1, wherein aligning the audio data with the image data in time comprises:
determining a target data amount based on the time delay and a target code rate; and
aligning the audio data with the image data in time by removing the target data amount of the audio data from a start position of the audio data.

5. The method of claim 1, wherein the time delay comprises at least one of:
a conversion time delay caused by obtaining the converted sound data based on the input sound data, or
a capture time delay caused by obtaining sound data with a microphone.

6. The method of claim 5, further comprising:
transmitting, to a remote device, the input sound data and a request for performing the target conversion operation on the input sound data;
receiving the converted sound data from the remote device; and
obtaining the conversion time delay based on the transmission of the input sound data and the reception of the converted sound data.

7. The method of claim 1, wherein the input sound data comprises a voice of the target object, and the target conversion operation comprises converting the voice into a user-specified timbre.

8. The method of claim 7, wherein the image data comprises a facial image of the target object.

9. The method of claim 1, further comprising:
receiving a user input indicating content shooting;
in response to the user input, triggering concurrent capture of the image data and the input sound data.

10. An electronic device, comprising:
at least one processing unit;
at least one memory coupled to the at least one processing unit and storing instructions for execution by the at least one processing unit, wherein the instructions, when executed by the at least one processing unit, cause the electronic device to perform at least:
receiving concurrently captured image data and input sound data from a target object;
generating audio data based at least on converted sound data corresponding to the input sound data, the converted sound data being obtained by performing a target conversion operation on at least a portion of the input sound data;
aligning the audio data with the image data in time based on a time delay associated with the converted sound data; and
generating multimedia content associated with the target object based on the aligned audio data and image data.

11. The electronic device of claim 10, wherein generating the audio data comprises:
obtaining background sound data played concurrently with capturing the input sound data and the image data;
aligning the converted sound data with the background sound data in time based on the time delay; and
generating the audio data based on the aligned converted sound data and background sound data.

12. The electronic device of claim 11, wherein aligning the converted sound data with the background sound data in time comprises:
shifting a start position of the background sound data backwards in time based on the time delay.

13. The electronic device of claim 10, wherein aligning the audio data with the image data in time comprises:
determining a target data amount based on the time delay and a target code rate; and
aligning the audio data with the image data in time by removing the target data amount of the audio data from a start position of the audio data.

14. The electronic device of claim 10, wherein the time delay comprises at least one of:
a conversion time delay caused by obtaining the converted sound data based on the input sound data, or
a capture time delay caused by obtaining sound data with a microphone.

15. The electronic device of claim 14, wherein the electronic device is further caused to perform:
transmitting, to a remote device, the input sound data and a request for performing the target conversion operation on the input sound data;
receiving the converted sound data from the remote device; and
obtaining the conversion time delay based on the transmission of the input sound data and the reception of the converted sound data.

16. The electronic device of claim 10, wherein the input sound data comprises a voice of the target object, and the target conversion operation comprises converting the voice into a user-specified timbre.

17. The electronic device of claim 16, wherein the image data comprises a facial image of the target object.

18. The electronic device of claim 10, wherein the electronic device is further caused to perform:
receiving a user input indicating content shooting;
in response to the user input, triggering concurrent capture of the image data and the input sound data.

19. A computer readable storage medium having a computer program stored thereon, wherein the computer program is executable by a processor to implement at least:
receiving concurrently captured image data and input sound data from a target object;
generating audio data based at least on converted sound data corresponding to the input sound data, the converted sound data being obtained by performing a target conversion operation on at least a portion of the input sound data;
aligning the audio data with the image data in time based on a time delay associated with the converted sound data; and
generating multimedia content associated with the target object based on the aligned audio data and image data.
